(19) United States
(12) Patent Application Publication
(10) Pub. No.: US 2013/0151999 A1
(43) Pub. Date: Jun. 13, 2013

(54) Providing Additional Information to a Visual Interface Element of a Graphical User Interface

(71) Applicant: International Business Machines Corporation, Armonk, NY (US)

(72) Inventor: Matthias Seul, Kassel (DE)

(73) Assignee: International Business Machines Corporation, Armonk, NY (US)

(21) Appl. No.: 13/686,586

(22) Filed: Nov. 27, 2012

(30) Foreign Application Priority Data
Dec. 9, 2011 (EP) 11192718.2

(51) Int. Cl. G06F 3/048

(52) U.S. Cl. CPC G06F 3/048
USPC 715/762

(57) ABSTRACT

A mechanism provides additional information to a visual interface element of a graphical user interface in an operating system environment. To display the additional information to the visual interface element on the information container layer, a background service process determines for each of the visual interface elements of the graphical user interface whether at least one configured context is assigned; collecting information across all applications from at least one information or status source related to the at least one assigned context; generating and placing a corresponding information container on the information container layer to be visible at a relative position to the corresponding visual interface element of the graphical user interface on the display area.

### BACKGROUND

The present invention relates in general to the field of graphical user interfaces, and in particular to a mechanism for providing additional information to a visual interface element of a graphical user interface.

Today's software systems have become sophisticated and complex in reaction to the increased requirements of the processes they support or provide. When working with these systems users are faced with the problem of information being stored and/or represented out of context. This increases work complexity and likelihood of user errors as vital information has to be drawn from different systems/interfaces and unified by the user.

Since companies oftentimes employ “best tool for the job” strategies the IT infrastructure becomes segmented with many systems existing in an isolated environment unaware of the overall status or related systems. Additionally most software is being provided by third-party vendors upon which users have only little influence in regards to changes or improvements of user interfaces to add information they might need in their specific environment.

Most user interfaces—especially in server application—have become complex and require intimate knowledge of the system to understand certain settings that have been set. This knowledge often isn't properly shared between individuals, gets forgotten or is stored down out of context, e.g. a readme file on the desktop, a Wiki entry etc. When confronted with a complex interface the current user may not know or remember why specific settings were put in place. Also often he/she is unable to communicate with colleagues or other persons responsible for the system why certain adjustments were made (“leaving a note”).

Known prior art approaches for handling extension of user interfaces were either targeted at a specific application being extended as part of a corresponding development or at actually injecting new interface elements into a visual interface element also known as “window controls” of other applications.

Further stand-alone solutions for annotations or information containers are used in the past. Notable examples are the ability to comment in text in word processors or adding notes to text documents. Certain software has the ability to add notes to certain settings, for example notes can be added to database elements. Other vendors provide “stick notes for the web”, which may be attachable to websites. Further vendors provide a functionality offering a layer on top of the desktop, only allowing widgets to be displayed that do not interact or integrate with the underlying interface elements.

All the above mentioned solutions are isolated in their individual environment and will not work across applications. A user has to employ several solutions to solve the problem and has no unified means to get a unified experience across all applications.

In the Patent Application Publication US 2011/0125756 A1 “PRESENTATION OF INFORMATION BASED ON CURRENT ACTIVITY” by Spence et al. a data elevation architecture for automatically and dynamically surfacing to a user interface context-specific data based on specific workflow or content currently being worked on by a user is disclosed. The disclosed architecture provides a mechanism for the automatic and dynamic surfacing or elevating of context-specific data based on the specific relation of the data to the task in which the user is currently engaged, e.g., filling out a business form, in a user interface (UI). The solution is a means to manage data in sets that are smaller than the document and to provide the specific and related data up to the work surface within the work environment of other sets of data to which it is related. So, the problem of automatically gathering and presenting information to the user based on a current work context is addressed, but the way information should be displayed inside affected applications is not defined. Further, it is focused on determining what kind of document the user is currently working on and then selecting the most appropriate gathered information piece in size and length related to the user's system.

### SUMMARY

The technical problem underlying the present invention is to provide a method and a system for providing additional information to a visual interface element of a graphical user interface, which are able to provide a unified platform to acquire, evaluate and integrate information into existing applications without requiring any changes to said applications and to solve the above mentioned shortcomings and pain points of prior art user interfaces.

According to an illustrative embodiment this problem is solved by providing a method for providing additional information to a visual interface element of a graphical user interface, a system for providing additional information to a visual interface element of a graphical user interface, and a computer program product for providing additional information to a visual interface element of a graphical user interface.

Accordingly, in an illustrative embodiment a method for providing additional information to a visual interface element of a graphical user interface in an operating system environment comprises implementing an information container layer running across all applications on top of a display area, configuring at least one context defining a predefined state of the operating system environment based on at least one collected information or status information in the operating system environment, and assigning the at least one context to at least one visual interface element. The method further comprises starting a background service process to display the additional information to the visual interface element on the information container layer by determining for each of the visual interface elements of the graphical user interface whether at least one configured context is assigned; if at least one configured context is assigned, collecting and storing information across all applications from the at least one information or status source related to the at least one assigned context; evaluating the collected information to determine a state of the at least one assigned context; generating and placing a corresponding information container on the information container layer in a way that it is visible at a relative position to the corresponding visual interface element of the graphical user interface on the display area.

In another embodiment, a system for providing additional information to a visual interface element of a graphical user interface in an operating system environment comprises an information container layer running across all applications on top of a display area; at least one sensor collecting information and status information in the operating system environment; and at least one context assigned to at least one visual interface element defining a predefined state of the operating system environment based on the at least one information or status information in the operating system environment. The system further comprises a data storage to store the collected information and status information and a background service process performing determining for each of the visual interface elements of the graphical user interface whether at least one configured context is assigned; if at least one configured context is assigned, collect and store information across all applications related to the at least one assigned context using the at least one sensor; evaluating the collected information to determine a state of the at least one assigned context; generating and placing a corresponding information container on the information container layer in a way that it is visible at a relative position to the corresponding visual interface element of the graphical user interface on the display area.

In yet another embodiment, a computer program product stored on a computer-usable medium, comprises computer-readable program means for causing a computer to perform a method for providing additional information to a visual interface element of a graphical user interface when the program is run on the computer.

The above, as well as additional purposes, features, and advantages of the present invention will become apparent in the following detailed written description.

### BRIEF DESCRIPTION OF THE SEVERAL VIEWS OF THE DRAWINGS

A preferred embodiment of the present invention, as described in detail below, is shown in the drawings, in which

FIG. 1 is a schematic block diagram of a system for providing additional information to a visual interface element of a graphical user interface, in accordance with an illustrative embodiment;

FIG. 2 is a schematic diagram of a graphical user interface with a display area displaying a visual interface element;

FIG. 3 is a schematic diagram of an information container layer with an information container;

FIG. 4 is a schematic diagram of the graphical user interface of FIG. 2 combined with the information container layer of FIG. 3, in accordance with an example embodiment;

FIG. 5 is a schematic diagram of the graphical user interface of FIG. 2 combined with the information container layer of FIG. 3, in accordance with an example embodiment;

FIG. 6 is a schematic flow diagram of a method for providing additional information to a visual interface element of a graphical user interface, in accordance with an illustrative embodiment;

FIG. 7 is a schematic flow diagram of sensor setup process being part of the method for providing additional information to a visual interface element of a graphical user interface of FIG. 6, in accordance with an illustrative embodiment;

FIG. 8 is a more detailed flow diagram of the sensor setup process of FIG. 7;

FIG. 9 is a more detailed flow diagram of a visual interface element enumeration/scanning being part of the method for providing additional information to a visual interface element of a graphical user interface of FIG. 6, in accordance with an illustrative embodiment;

FIG. 10 is a schematic flow diagram of context data processing being part of the method for providing additional information to a visual interface element of a graphical user interface of FIG. 6, in accordance with an illustrative embodiment;

FIG. 11 is a more detailed flow diagram of the context data processing of FIG. 10;

FIG. 12 is a schematic flow diagram of reaction and/or plugin processing being part of the method for providing additional information to a visual interface element of a graphical user interface of FIG. 6, in accordance with an illustrative embodiment;

FIG. 13 is a more detailed flow diagram of the reaction and/or plugin processing of FIG. 12; and

FIG. 14 is a schematic flow diagram of plugin and/or visual response processing being part of the method for providing additional information to a visual interface element of a graphical user interface of FIG. 6, in accordance with an illustrative embodiment.

### DETAILED DESCRIPTION

All in all, the illustrative embodiments are focused on the problem of displaying previously gathered or stored information as part of an already existing application as well as extending the application with additional controls—all with the goal of working with any standard windowed application and being able to extend it without requiring any changes to the application in binary code or during runtime. The approach to simply mimic the extension of any application with additional controls and information without doing any changes to said application is the main idea of the illustrative embodiments.

By layering interface additions generated and displayed dynamically based on the current work context of the user, and conditions on top of user interface (UI) elements of running applications, the illustrative embodiments create the illusion of direct integration without actually modifying any part of the application. Since generation and layering are real-time and dynamic, the user will not be able to tell the difference while reaping all of the benefits of attaching any kind of information to any visible part of the application.

The illustrative embodiments aim to provide a universal approach to provide users to place information containers and interface extensions comparable to real-world “sticky notes” to specific parts of an existing user interface. These information containers can hold any type of information, including (but not limited to) simple formatted text to images, hyperlinks or interface extensions such as new buttons. Information can be stored and exchanged between individual clients enabling collaboration.

The key of the innovation is that the display of these information containers is available system wide and tied to specific interface elements by displaying them on a separate layer, the so called “Information Container Layer” that is placed on top of the whole display area. The layer is transparent to the user and his/her actions unless information containers are displayed.

All information containers will therefore not get embedded into the targeted interface elements but will be placed on top of the targeted interface elements as an overlay, therefore requiring no changes to the code of the interface elements.

The illustrative embodiments work with any application that uses standard window controls, extend existing displays instead of creating an isolated solution, deliver information directly to where it is relevant, are able to display a wide range of data from simple text to additional button, react to the environment and display data only when relevant, aggregate and display data from multiple clients, and are built around the idea to improve communication between individuals.

The major aspect of the introduced embodiments is to place all the displayed information containers on an invisible “display layer” that spans the whole screen of the user. The layer normally is always-on and transparent to the activities of the user unless an information container has to be displayed or interacted with. The layer may be (partially or fully) enabled or disabled at any time. This allows the user to display notices when necessary or removing them at will. The display layer will generally not block actions of the user unless the information containers are configured to do so. An information container with an input field may react on the user and capture the keyboard and mouse input. An image could on the other hand be “clicked through,” reacting transparent to the actions of the user. This behavior is not tied to specific container types but individually configurable.

The data processing and interface layer are handled by a background service that is transparent to the user. The background service constantly scans the interface elements displayed and matches them against a database of interface elements that have received information containers. It checks if an interface element has the correct name, is in the correct state and window, owned by the correct process and if other environmental factors (time, state of other interface elements or components) match. It is thus possible to place a note next to a specific input field for a very important setting or leave a note for a colleague why a setting was changed. If a match is found the configured information container is displayed relative to the interface element it was attached to.

The display and type of information can depend on the state of the interface element they are attached to or the environment of the interface element. This means that information may for example be hidden if the targeted interface element is disabled. Also a container may only be shown if the state of an interface element changes to (or from) a pre-specified condition (e.g., different text in an input field).

Containers may also process detected changes to the attached interface elements. For example a container may watch the status of an input field and record all changes into a text container displayed next to it therefore creating change log containing what was changed, when, and by which logged in user.

Positioning of the information containers is relative to the interface element attached to them. Moving the interface element will move the container also. To the user the container will appear to “stick” to a certain position relative to the targeted interface element.

The interface elements supported are all standard window elements including (but not limited to) buttons, panels, input fields, radio buttons, checkboxes, and images. Any application using those interface elements will be supported.

Additional data can be added on the fly depending on the information container. A text container may allow for users to have a conversation similar to an instant messenger recording who said what and when. Also files may be placed into information containers to be available for later use and other users.

All data for the information containers is stored in a database. The background service will load and save data to and from that database on-demand, caching data locally if necessary. This activity happens automatically in the background and is transparent to the user. The database can be located remotely and will be accessed by the background service appropriately. It can be accessed by multiple clients therefore allowing the information to be distributed to and from different systems. Access management and user identification allow deciding who will see which type of information container and interact with it.

Embodiments of the present invention do not try to make direct changes to the applications being extended, neither in the form of binary changes nor in the form of aggressively changing the user interface of the extended application. Instead, illustrative embodiments go with the concept of simply tricking the user into believing that the provided extensions are actually integrated with the applications although they are technically still completely separated. The difference does not matter for normal workflows as the user still receives the same visual representation and response.

For people creating extensions or adding information the difference, however, is great since they no longer need to care about what they are modifying or whether the application supports extensions or not. They can add any and all information in any form to any visible interface control. This surpasses the capabilities of existing solutions as it is no longer limited by the extended application.

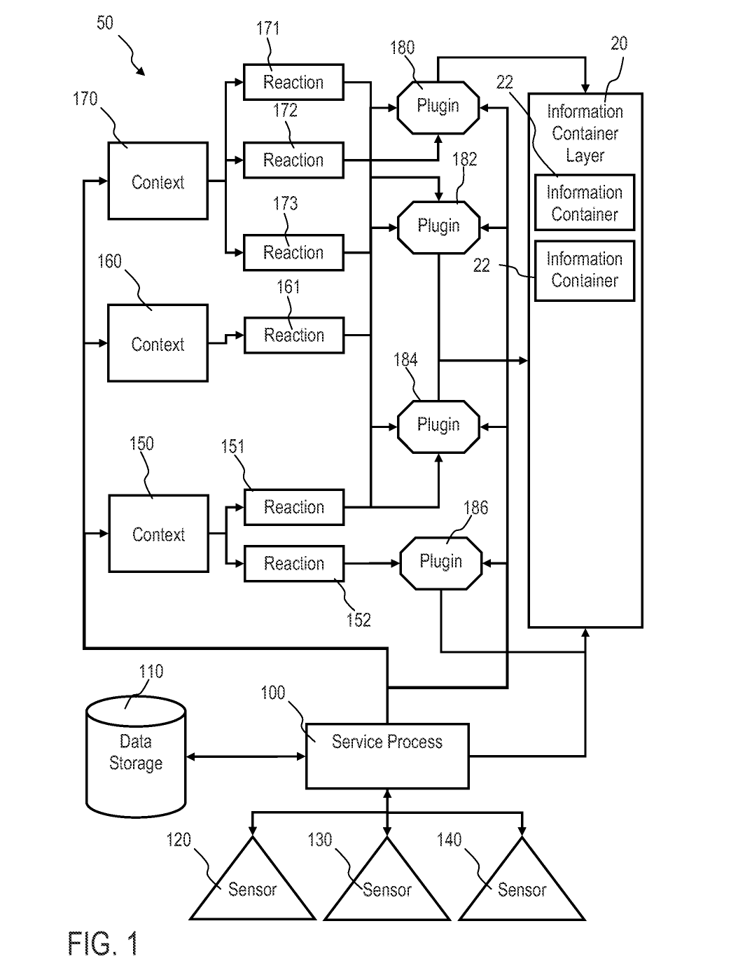

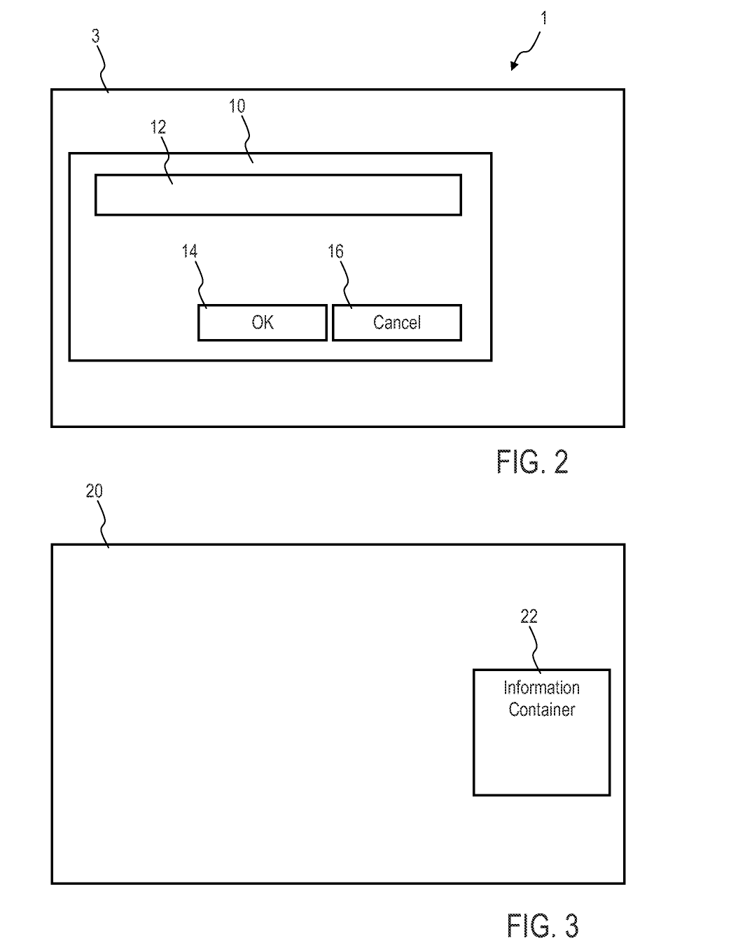

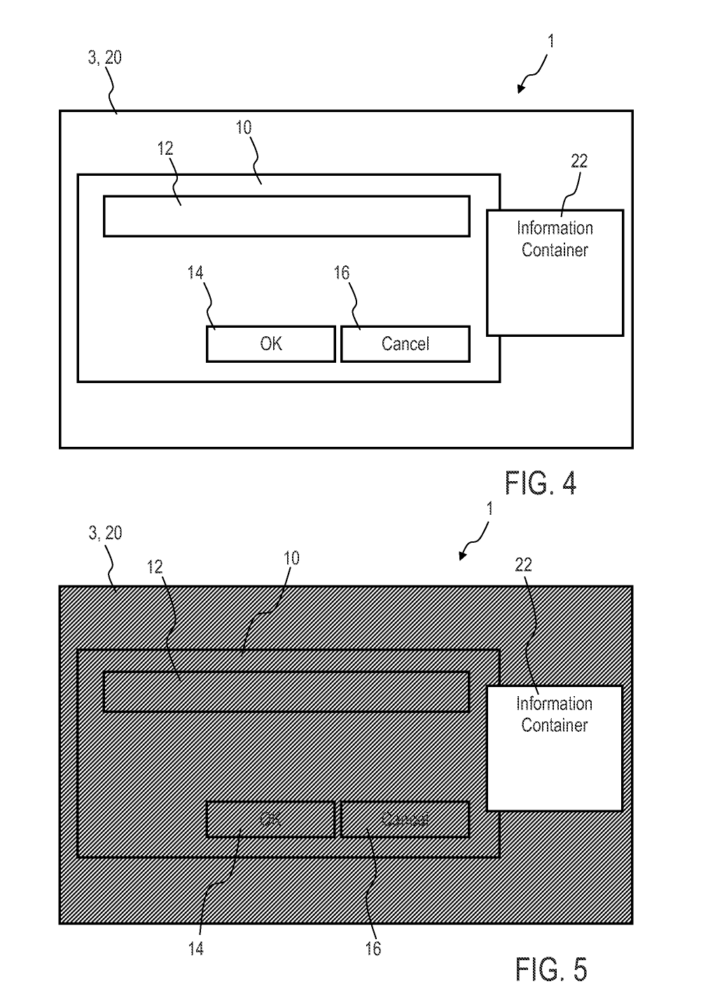

FIG. 1 shows a system 50 for providing additional information to a visual interface element 10 of a graphical user interface 1, in accordance with an illustrative embodiment; FIG. 2 shows the graphical user interface 1 with a display area 3 displaying the visual interface element 10; FIG. 3 shows an information container layer 20 with an information container 22; FIG. 4 shows the graphical user interface 1 of FIG. 2 combined with the information container layer 20 of FIG. 3, in accordance with an example embodiment; and FIG. 5 shows the graphical user interface of FIG. 2 combined with the information container layer 20 of FIG. 3, in accordance with an example embodiment.

Referring to FIG. 1 to 5, the shown embodiment employs a system 50 for providing additional information to a visual interface element 10 of a graphical user interface 1 in an operating system environment. The information system comprises an information container layer 20 running across all applications on top of a display area 3; at least one sensor 120, 130, 140 collecting information and status information in the operating system environment; and at least one context 150, 160, 170 assigned to at least one visual interface element 10 defining a predefined state of the operating system environment based on the at least one information or status information in the operating system environment. The at least one context 150, 160, 170 is considered active if the operating system environment is in said predefined state; otherwise, the at least one context 150, 160, 170 is considered inactive. The information system further comprises a data storage 110 to store the collected information and status information, and a background service process 100 performing the following steps to display the additional information to the visual interface element 10 on the information container layer 20: determining for each of the visual interface elements 10 of the graphical user interface 1 if at least one configured context 150, 160, 170 is assigned; if at least one configured context 150, 160, 170 is assigned, collecting and storing information across all applications related to the at least one assigned context 150, 160, 170 using the at least one sensor 120, 130, 140; evaluating the collected information to determine a state of the at least one assigned context 150, 160, 170; generating and placing a corresponding information container 22 on the information container layer 20 in a way that it is visible at a relative position to the corresponding visual interface element 10 of the graphical user interface 1 on the display area 3, if the state of the at least one assigned context 150, 160, 170 changes or remains for a certain amount of time.

Referring to FIG. 2, in the shown embodiment the visual interface element 10 of a standard dialog on the display area 3 comprises an input field 12 and two input buttons 14, 16.

Referring to FIG. 3, in the shown embodiment the information container layer 20 comprises one information container 22 assigned to the visual interface element 10.

Referring to FIG. 4, in the shown first embodiment of an extended dialog, the information container layer 20 is transparent and the information container 22 assigned to the visual interface element 10 is placed on the information container layer 20 in a way that it is visible at a relative position to the corresponding visual interface element 10 of the graphical user interface 1 on the display area 3.

Referring to FIG. 5, in the shown second embodiment of an extended dialog, the information container layer 20 is highlighted and the information container 22 assigned to the visual interface element 10 is placed on the information container layer 20 in a way that it is visible at a relative position to the corresponding visual interface element 10 of the graphical user interface 1 on the display area 3. In another embodiment of an extended dialog, not shown, the information container layer 20 is highlighted and the information container 22 assigned to the visual interface element 10 is placed on the information container layer 20 in a way that it is visible at a relative position to the corresponding visual interface element 10 of the graphical user interface 1 on the display area 3, wherein the visual interface element 10 is hidden.

The at least one Context 150, 160, 170 is based on the concept of the system entering or leaving a predefined state. A context 150, 160, 170 can be “Inactive” if the system is not in the expected state or “Active” if the system is in the expected state. To determine if the “Context” is active or inactive the information gathered by the sensors 120, 130, 140 is used.

The context 150, 160, 170 is made out of a number of information and/or status elements which can be, as described before, visual interface element 10 also called window controls, system metrics, and so on. These information and/or status elements are checked if their status matches a predefined value. This can be for example the central processing unit(CPU) usage of the system reaching a certain point for a certain amount of time, a specific visual interface element 10 and/or window control being enabled, an input field 12 receiving a certain input, a certain process being launched and so on. The information and/or status elements may also be checked if they do not match specific criteria, a process not running, the memory usage being below a certain value, the size of a file on a remote system being outside the range of bytes.

The evaluation result of each of these checks is reported by the sensors 120, 130, 140 back to the service process 100 which will then use it to determine the state of each configured context 150, 160, 170. The context 150, 160, 170 is considered “Inactive” unless all or a configurable number of monitored information/status elements are in an expected state, in which case the context is considered “Active”.

Associated with each context 150, 160, 170 are Reactions 151, 152, 161, 171, 172, 173 which are configurable actions the service process 100 will execute if the state of a context 150, 160, 170 changes or remains in a defined state for a certain amount of time. The Reactions 151, 152, 161, 171, 172, 173 maybe executed only once by a status change or in a certain interval since the last execution.

The reactions 151, 152, 161, 171, 172, 173 are targeted at extending the graphical user interface 1 with additional controls and information. These additions appear alongside the original interface elements 10 of the user interface 1 and are displayed in a way to seamlessly integrate with them. The Reaction 151, 152, 161, 171, 172, 173 can also trigger non-visual actions such as running a command, accessing a local and/or remote file and/or service, writing data to storage or other applications. The Reactions 151, 152, 161, 171, 172, 173 consist of several parts like content information, execution plugins, and program logic, for interactive or automated reactions 151, 152, 161, 171, 172, 173.

The content information of a reaction 151, 152, 161, 171, 172, 173 can be fixed texts, images or other content in form of templates which can be adapted using previously collected information by the sensors 120, 130, 140 and the state the reaction 151, 152, 161, 171, 172, 173 currently is in. The content information can be retrieved from the configuration of the reaction 151, 152, 161, 171, 172, 173 itself or a different data source. External data sources will be collected by the reaction 151, 152, 161, 171, 172, 173 prior to generating the information container 22. Also, as sensor data is continuously accumulated already displayed interface containers 22 and their contents will be updated as soon as new data has been collected.

The reaction 151, 152, 161, 171, 172, 173 can process gathered information using plugins 180, 182, 184, 186 which are loaded by the service process 100 and are used to generate interactive information container 22 based on the content information and program logic. The plugins 180, 182, 184, 186 cover basic window controls such as buttons, check- and radio boxes, lists and images as well as more specialized controls that can be created and provided in the form of additional plugins as needed. The plugins 180, 182, 184, 186 can also take actions which will yield no visible interface elements. These plugins for non-visual reactions can be used alone or in conjunction with plugins that generate visual information container all in the same reaction 151, 152, 161, 171, 172, 173. The plugins 180, 182, 184, 186 are run by the service process 100 and fed all the generated parameters and information provided by the reactions 151, 152, 161, 171, 172, 173 and associated sensors 120, 130, 140. They contain the code to generate the information container 22 depending on their type and can trigger program logic stored in the reaction 151, 152, 161, 171, 172, 173 based on a user interaction or non-interaction with the generated information container 22.

Since modern operating systems all work on the same or very similar principles, available functionality and application programming interfaces (APIs) might differ from operating system to operating system but in general all provide the same set of options. To realize the functionality outlined in the illustrative embodiments, the service process 100 is created first. The service process 100 is a program running invisibly in the background, and is possibly launched at the start of the operating system or a user session. Background processes are common in modern operating systems and provide any number of services from simple status monitoring to large-scale database servers. The service process 100 functions as a host process loading additional modules, such as sensors 120, 130, 140 and response plugins 180, 182, 184, 186 to extend its capabilities and managing the flow of information and program logic which turns information gathered to actions taken.

The first functionality to be provided is the contexts 150, 160, 170 as they are the center point where information is gathered and reacted upon. The contexts 150, 160, 170 can function as information collectors taking in sensor data and responding to certain combinations of this data by triggering associated reactions 151, 152, 161, 171, 172, 173. The contexts 150, 160, 170 will most likely be set up manually by a user who will be presented a list of sensors 120, 130, 140 supported by the service process 100. The user will then be able to determine what part of the environment the sensors 120, 130, 140 will monitor and what values are expected for the context 150, 160, 170 to be considered “Active”.

For sensors 120, 130, 140 that target non-visual information, such as remote systems, files on the disk, system performance counters, this would be done by having the user enter the target to monitor, e.g. the full path to a disk, and then the expected result of the monitoring. The user can define multiple sensors and results per sensor which are expected. The user can then specify how many of these results should be “True”, meaning expected value matches value read from the sensor 120, 130, 140, for the contexts 150, 160, 170 to be considered “active”.

After having defined that part of the context 150, 160, 170, the user will move on to configuring the reactions 151, 152, 161, 171, 172, 173. The reactions 151, 152, 161, 171, 172, 173 can be assigned both static information such as predefined texts, file paths and so on as well as dynamic information gathered from the sensors 120, 130, 140. The sensors 120, 130, 140 assigned to reactions 151, 152, 161, 171, 172, 173 do not necessarily have to be used by the context 150, 160, 170 triggering the reaction 151, 152, 161, 171, 172, 173. Sensors 120, 130, 140 can be added to a reaction 151, 152, 161, 171, 172, 173 for the sole purpose of proving additional information, for example the status of a remote service, the contents of a file and similar. Reactions 151, 152, 161, 171, 172, 173 can then feed all the information they have at their disposal into plugins 180, 182, 184, 186 that have been assigned to them by the user.

The plugins 180, 182, 184, 186 control how a reaction 151, 152, 161, 171, 172, 173 will materialize on the system which is running the service process 100. They are loaded by the service process 100 and are executed in its context 150, 160, 170. The plugins 180, 182, 184, 186 internal logic determines how the provided data will be interpreted and reacted upon.

The status of the plugins 180, 182, 184, 186 as well as their execution state may be influenced by the state of the context 150, 160, 170 and/or reaction 151, 152, 161, 171, 172, 173 originally triggering them. Thus if a context 150, 160, 170, for example, leaves the “Active” state associated reactions 151, 152, 161, 171, 172, 173 and plugins 180, 182, 184, 186 would stop whatever action they were doing.

After setting up the whole sensor-context-reaction-plugin chain, the configuration can be saved in a general data store 110 that can be read out by the service process. This data store 110 can reside on the same system as the service process, be on a remote system or synchronized with it allowing configurations to propagate across multiple systems.

Using this concept an administrator for example could set up the following configuration: Sensor A checks if a remote service is responding to a predefined request in a specific fashion, for example a “Status” request must be answered with “100 Service Ready”. Sensor B is configured to check if a specific process is emitting a login window. The process is dependent on the status of the server but has no own method of displaying the server status. The login window is identified by its parent process, title and internal name.

Now a context is created to check if the sensor A does not report the expected result (the service is not in status “100 Service Ready”) and sensor B does report the expected result (the Login window is visible). If these two conditions are present, the context is set to “Active”.

If the context is switched to active, the administrator configures a response that receives a preset text (“Service unavailable. Call support at XXX-XXXXX”) and will pass it, along with position information of the login dialog gathered by sensor B, to the plugin “Show Notice Sticky”.

The plugin takes in the predefined text and position information. Using the position information and length of the text, it determines its height and width. From this it generates the target X and Y coordinates to display its visual manifestation. It will then generate a visual information container similar to a yellow sticky note containing the preset texts (“Service unavailable . . . ”) at the determined X and Y coordinates. As parent window it will set the information container layer 20 of the service process 100. The administrator will save this configuration and have it propagate to all client machines running an instance of the service process 100. As a result, the service process 100 on the user system will display the sticky note whenever the monitored server leaves the “100 Service Ready” status and a user tries to log in to the server (and thus has the login dialog open). The users can now immediately see if the program they are trying to login in to will not work properly if the required server is down although the program itself has no built-in capability of displaying the status on its own.

The service process 100 contains several sensors 120, 130, 140 which are specialized pieces of code that can be configured to look into different parts of the system. The sensors 120, 130, 140 are self-contained libraries along the lines of Dynamic Link Libraries of Windows and Shared Objects of Linux, and can be loaded by the service process 100 and accessed using a generalized interface providing functions such as configuration of sensor, starting the monitoring, stopping the monitoring, a callback to drop-off new data as soon as it is available, and a status query function to determine the internal status of the sensor.

All parts of the system such as the file system, performance counters (CPU load, memory, etc.), window controls, remote resources are available in modern operating system using the system's APIs or common libraries such as the STL, ACE or similar.

APIs are different from operating system to operating system but all follow the same principle. The sensors simply use the APIs provided to access preconfigured paths available in the system. For example to check if a specific login dialog is visible, the sensor would first use the window enumeration API to get a listing of all visible windows. It would then check if a window belongs to the process that normally generates the login dialog. If process is not running or not generating any windows, the sensor will report this information back. If the process however is running and has generated a window that matches type, size, and content as preconfigured, the sensor 120, 130, 140 can then report that the window has been located and is visible.

Data on visible window controls or visual interface elements 10 can be shared or enumerated in a streamlined fashion as to service all sensors 120, 130, 140 looking for window controls or visual interface elements 10. This avoids having each sensor 120, 130, 140 check the whole lot of visible windows. Sensor findings go into a data storage 110 which can be any kind of common storage concept, such as files, a structure in the memory of the service process 100, and an SQL database and so on.

The plugins 180, 182, 184, 186 are the main way of the service process 100 to affect the system. The plugins 180, 182, 184, 186 are running on by taking action due to a triggered reaction 151, 152, 161, 171, 172, 173. Plugins 180, 182, 184, 186 contain all the necessary programming and logic to handle whatever task they are setup to do. Similar to the sensors 120, 130, 140 they are provided in form of self-contained libraries, for example, and loadable by the service process 100 as necessary. All plugins 180, 182, 184, 186 provide a generalized interface with functionality such as: configure plugin, start plugin execution, stop plugin execution, upload new configuration data during plugin execution, and query the plugin status.

Theplugins 180, 182, 184, 186 receive data to work with from the reactions 151, 152, 161, 171, 172, 173. Depending on the type of plugin, the manifestation of the plugin on the system can be very different or unique. Expected types would be, for example, a sticky note, displaying a text built from the provided data; being a visual representation looking similar to a real-world sticky note; sticking to a part of the interface of an application; accepting positional data to know the X and Y coordinates at which to be rendered; being updated with new data while running; having internal logic to make the visual representation invisible due to user interaction; a interface extension looking as integrated with the interface of the extended Application; being a visual representation taking the shape of common window controls, like button, input field, text; wherein shape, position, size and content can be dependent on data provided; accepting positional data to know the X and Y coordinates at which to be rendered, being updated with new data while running; having internal logic to react on user interaction; and wherein sensors 120, 130, 140 can react to changes to this control.

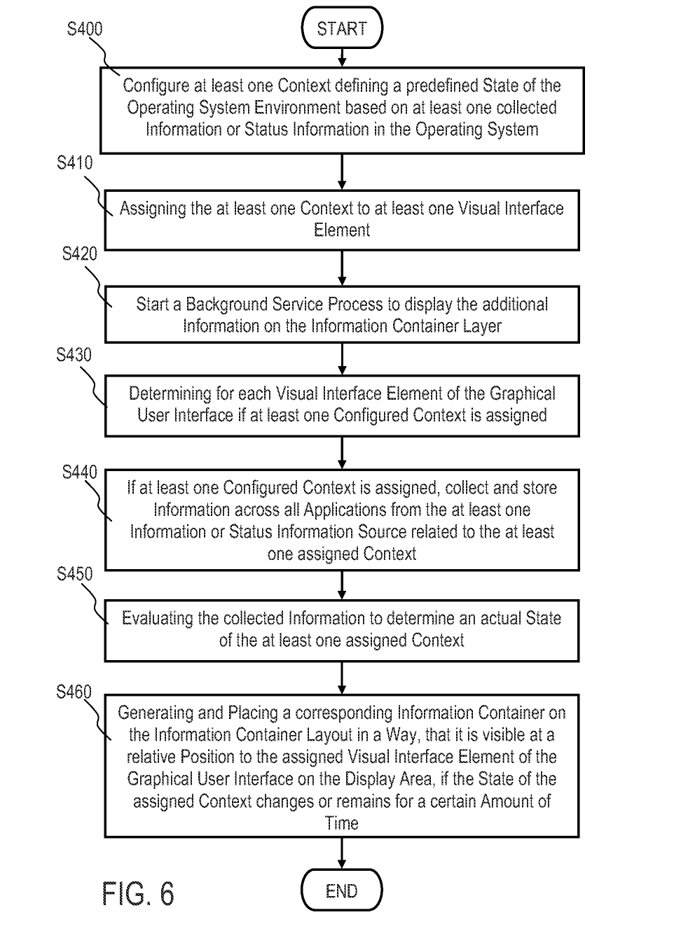

Referring to FIG. 6 to 15 embodiments of methods for providing additional information to a visual interface element 10 of a graphical user interface 1 in an operating system environment are described, wherein an information container layer 20 is implemented running across all applications on top of a display area 3.

Referring to FIG. 6, in step S400 at least one context 150, 160, 170 defining a predefined state of the operating system environment is configured based on at least one collected information or status information in the operating system environment, and assigned to at least one visual interface element 10, in step S410. The at least one context 150, 160, 170 is considered active if the operating system environment is in said predefined state; otherwise, the at least one context 150, 160, 170 is considered inactive. To display the additional information to the visual interface element 10 on the information container layer 20 a background service process 100 is started in step S420. In step S430, for each of the visual interface elements 10 of the graphical user interface 1 it is determined whether at least one configured context 150, 160, 170 is assigned. If at least one configured context 150, 160, 170 is assigned, information across all applications is collected and stored from the at least one information or status source 120, 130, 140 related to the at least one assigned context 150, 160, 170, in step S440. In step S450, the collected information to determine a state of the at least one assigned context 150, 160, 170 is evaluated. In step S460, a corresponding information container 22 is generating and placed on the information container layer 20 in a way that it is visible at a relative position to the corresponding visual interface element 10 of the graphical user interface 1 on the display area 3, if the state of the at least one assigned context 150, 160, 170 changes or remains for a certain amount of time.

Any modern operating system displays user interface elements 10 consisting of “window controls” which have become an accepted standard across all platforms. These window controls are for example: Window (an actual program window); dialog (a dialog hovering over the program window); buttons; input fields; radio- and checkbox-buttons; dropdown controls; images; and many more.

Most of these controls, regardless of their shape and function, have the same set of properties: they are attached to a parent control; they can be enumerated by starting and the root control; they have a size; they have type/class; they have a fixed or predictable object name; they have a relative and absolute screen position; they have certain states such as “visible” or “enabled”; some of the controls also contain readable information such as text.

A control is made unique by recording all properties of the control. This record of the properties can then be used to identify the control among any number of other, similar controls. To get a more general selection of controls (e.g. “all buttons”) one can focus only on certain properties that these controls have in common.

Once a control has been properly identified and located environmental information can be used to determine the status and surroundings of the control. The available information includes the parent control (and in turn all of the properties and conditions of the parent control); a process providing this control; logged-in user; and information of other sources such as system metrics (CPU/Memory usage, configuration of the machine), files on the disk or of a remote system, information retrieved from a connection to a remote system, information from a database.

Additionally one may simply rely on environmental information to react to non-visual contexts such as certain background processes running, remote system status and so on.

This information is stored in the machine-readable storage 110 which can be any kind of file- or disk-based storage concept or a remote storage location. Common forms of this storage can be a database or a disk file.

The information is retrieved by the service process 100 which runs invisibly in the background on the user system. The service process 100 contains several sensors 120, 130, 140 which are targeted at gathering current status of the system. The sensors 120, 130, 140 are each specialized to cover sections of the components and functionality of the system.

To read out the system information the sensors 120, 130, 140 access the system and other program APIs or interfaces to read metrics and status information; access the window manager of the system to scan for visual interface elements 10 or window controls; access local and remote information sources such as files, TCP-connections and similar elements.

To avoid potential performance issues the sensors 120, 130, 140 will not always map the whole system status but only look in specific areas of the system.

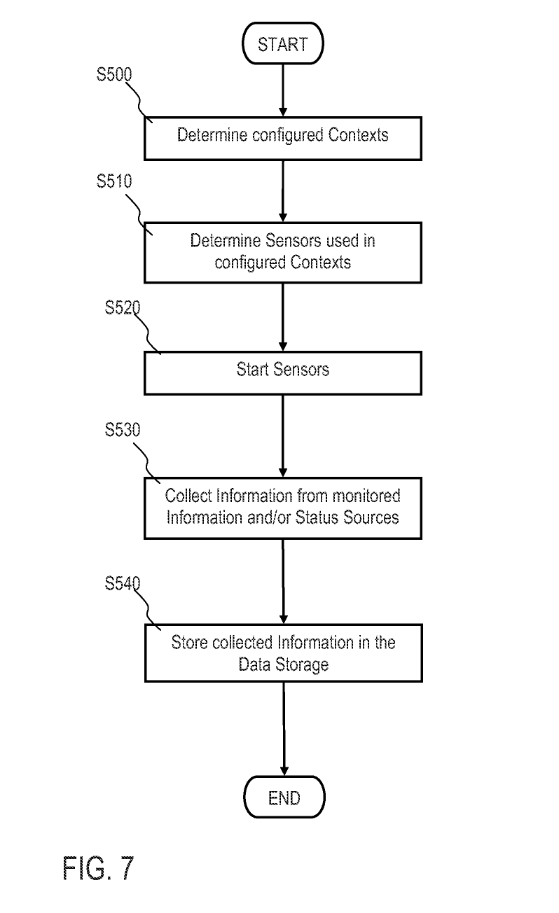

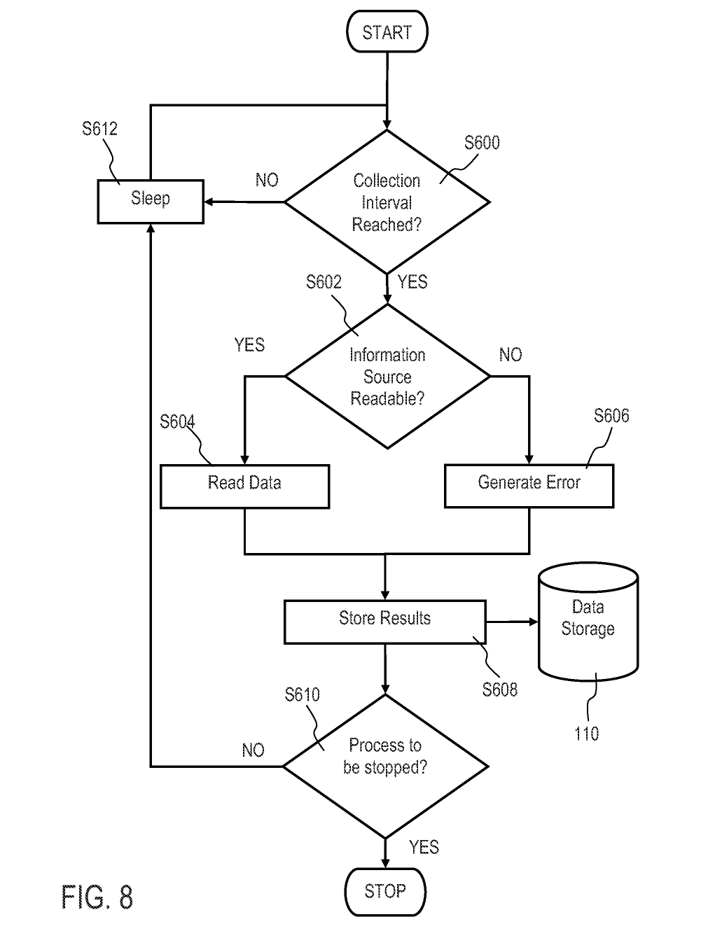

FIG. 7 and 8 show a sensor setup process being part of the method for providing additional information to a visual interface element of a graphical user interface, in accordance with an illustrative embodiment.

Referring to FIG. 7, in step S500, the configured contexts 150, 160, 170 are determined. In step S510 the sensors 120, 130, 140 used in the configured contexts 150, 160, 170 are determined. In step S520 the sensors 120, 130, 140 used in the configured contexts 150, 160, 170 are started. In steps S530, the sensors 120, 130, 140 used in the configured contexts 150, 160, 170 collect information form monitored information or status sources in the system. In step S540, the collected information is stored in the data storage 110.

Referring to FIG. 8, in step S600 it is verified, if the corresponding sensor 120, 130, 140 is used and has reached the collection interval. The sensor 120, 130, 140 is brought in a sleep state in step S612, if the collection interval is not reached. If the collection interval is reached, it is verified in step S602, if the information source is readable. If the information source is not readable, an error signal is generated in step S606. If the information source is readable, the corresponding data is read in step S604, and the results are stored in the data storage 110 in step S608. In step S610 it is verified, if the process has to be stopped. If the Process is not to be stopped, the sensor is brought in in sleep state by performing step S612, waiting for a new process start, otherwise the process is stopped.

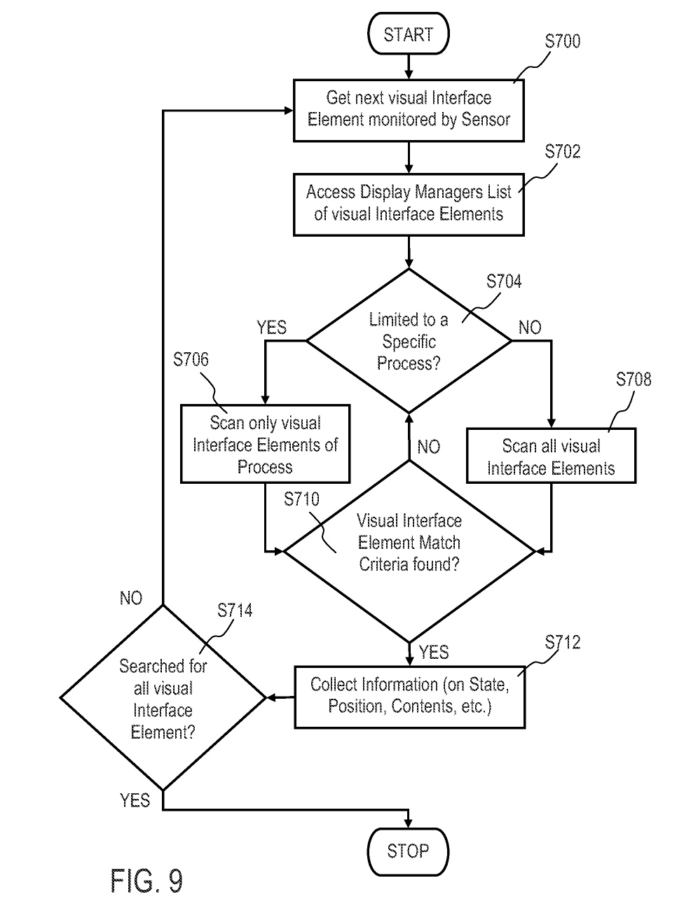

FIG. 9 shows a visual interface element enumeration/scanning being part of the method for providing additional information to a visual interface element of a graphical user interface, in accordance with an illustrative embodiment.

Referring to FIG. 9, in step S700 the next visual interface element 10 monitored by a sensor 120, 130, 140 is looked for. Therefore a display manager list of visual interface elements 10 is accessed in step S702. In step S704, it is verified whether the search is limited to a specific process. If the configured context 150, 160, 170 is not limited to a specific process, all visual interface element 10 are scanned in step S708. If the configured context 150, 160, 170 is limited to a specific process only the visual interface element 10 of the corresponding process are scanned in step S706. In step S710 it is determined whether match criteria have been found for the visual interface elements 10. If no match criteria have been found, the steps S704 to S708 are repeated. If match criteria have been found the corresponding information is collected in step S712. Then it is verified in step S714 whether the search has been done for all visual interface elements 10. If the search was done for all visual interface elements 10, the process is stopped. If the search was not done for all visual interface elements 10 the process returns to step S700.

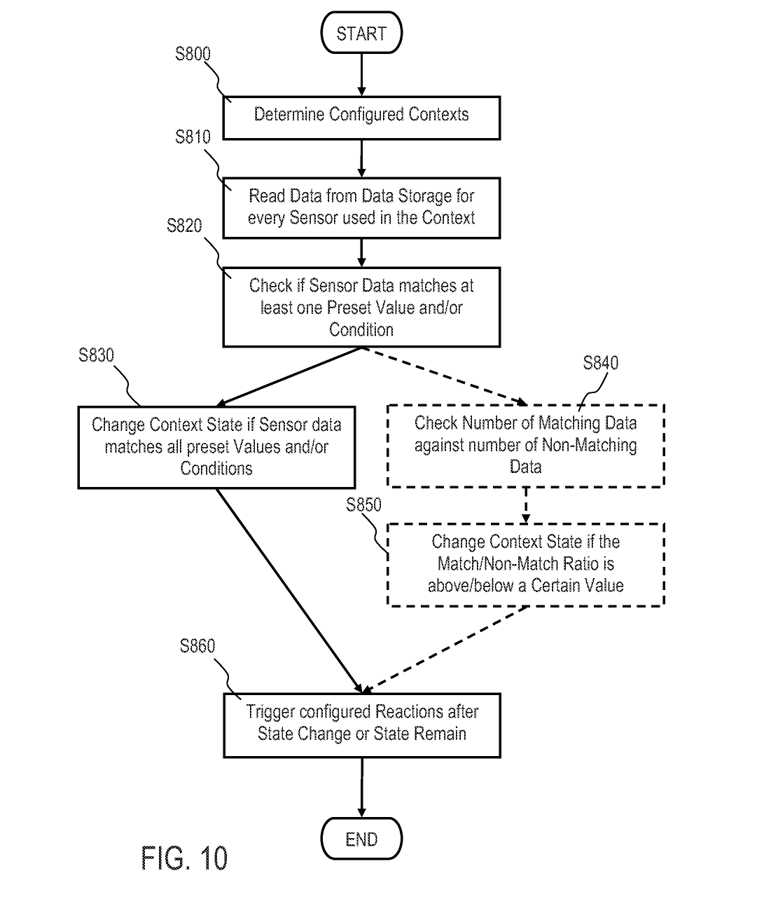

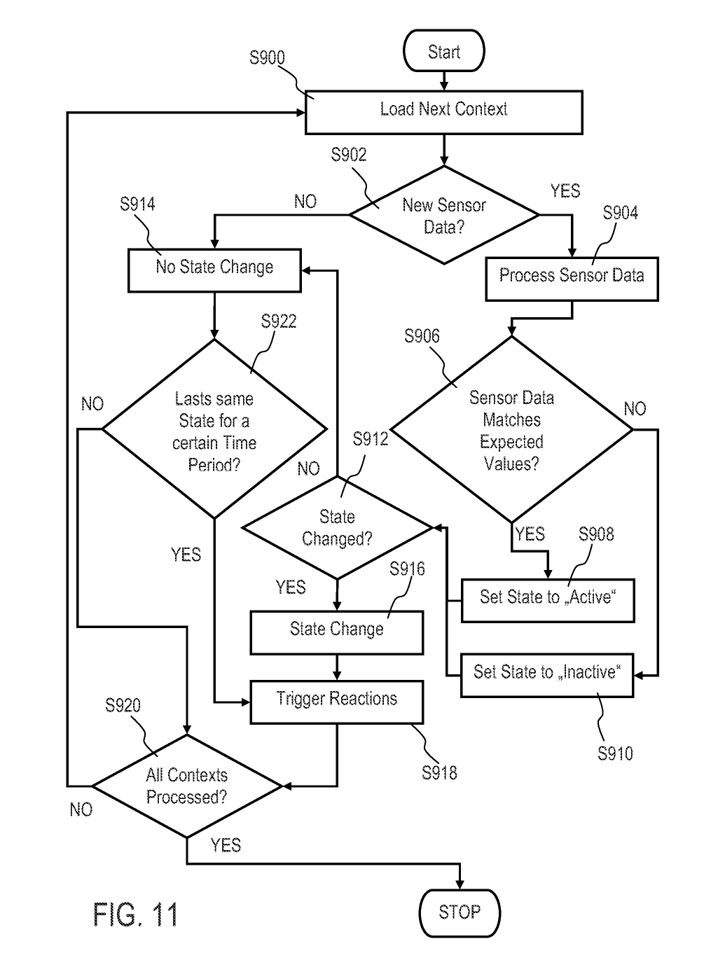

FIG. 10 and 11 show a context data processing being part of the method for providing additional information to a visual interface element of a graphical user interface, in accordance with an illustrative embodiment.

Referring to FIG. 10, in step S800, the configured contexts 150, 160, 170 are determined. In step S810, data is read from the data storage 110 for every sensor 120, 130, 140 used in the configured contexts 150, 160, 170. In step S820, it is verified whether the sensor data matches at least one preset value and/or condition. In an embodiment of the process the state of the corresponding configured context 150, 160, 170 is changed in step S830, if the sensor data match all preset values and/or conditions. In an alternative embodiment of the process a number of matching sensor data is determined and verified against a number determined non-matching sensor data in step S840. In step 850, the actual state of the corresponding configured context 150, 160, 170 is changed in step S860, if a ratio of the matching sensor data to the non-matching sensor data is above and/or below a certain value, depending on the configuration of the corresponding context 150, 160, 170. In step S840, configured reactions 151, 152, 161, 171, 172, 173 are triggered after state change of the corresponding configured context 150, 160, 170 or remaining of the corresponding configured context 150, 160, 170 in a state for a certain amount of time.

Referring to FIG. 11, in step S900 a configured context 150, 160, 170 is loaded. In step S902, it is verified whether new sensor data have been collected. If no new sensor data have been collected, no state change of the corresponding context 150, 160, 170 is verified in step S914. If new sensor data have been collected, the new sensor data will be processed in step S904. In step S906, it is checked whether the sensor data match expected values. If the sensor data do not match the expected values the state of the corresponding contexts 150, 160, 170 is set to “Inactive” in step S910. If the sensor data match the expected values the state of the corresponding contexts 150, 160, 170 is set to “Active” in step S908. In step 912, it is determined whether the state of the corresponding context 150, 160, 170 has changed. If the corresponding context 150, 160, 170 has not changed state, the no state change condition is settled in step S914. In step S922, it is verified whether the same state of the corresponding context 150, 160, 170 last for a certain time period. If the same state of the corresponding context 150, 160, 170 does not last for the certain time period, the process is continued with step S920. If the same state of the corresponding context 150, 160, 170 lasts for the certain time period, the process is continued with step S918. If the corresponding context 150, 160, 170 has changed state, the state change condition is settled in step S916. In step S918, configured reactions 151, 152, 161, 171, 173, 175 are triggered. In step S920, it is determined whether all configured contexts 150, 160, 170 have been processed. If not all configured contexts 150, 160, 170 have been processed, the process will return to step S900 and load the next configured context 150, 160, 170. If all configured contexts 150, 160, 170 have been processed, the process will be stopped.

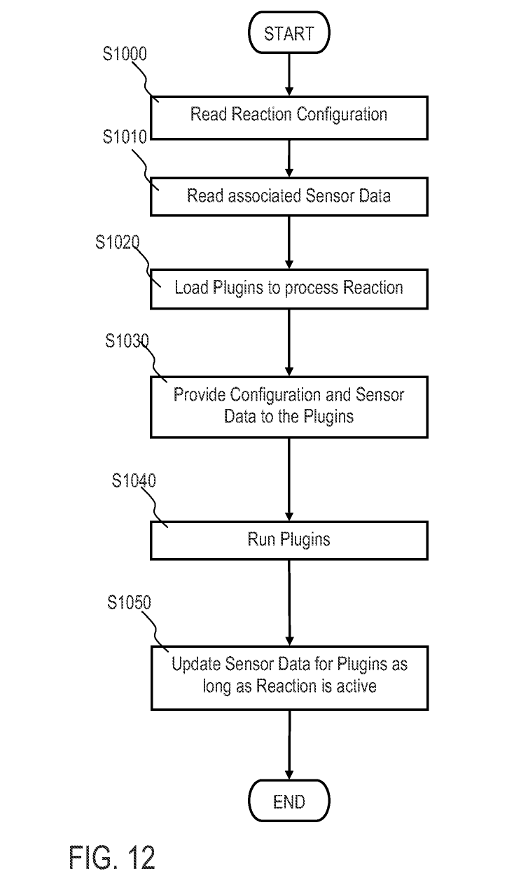

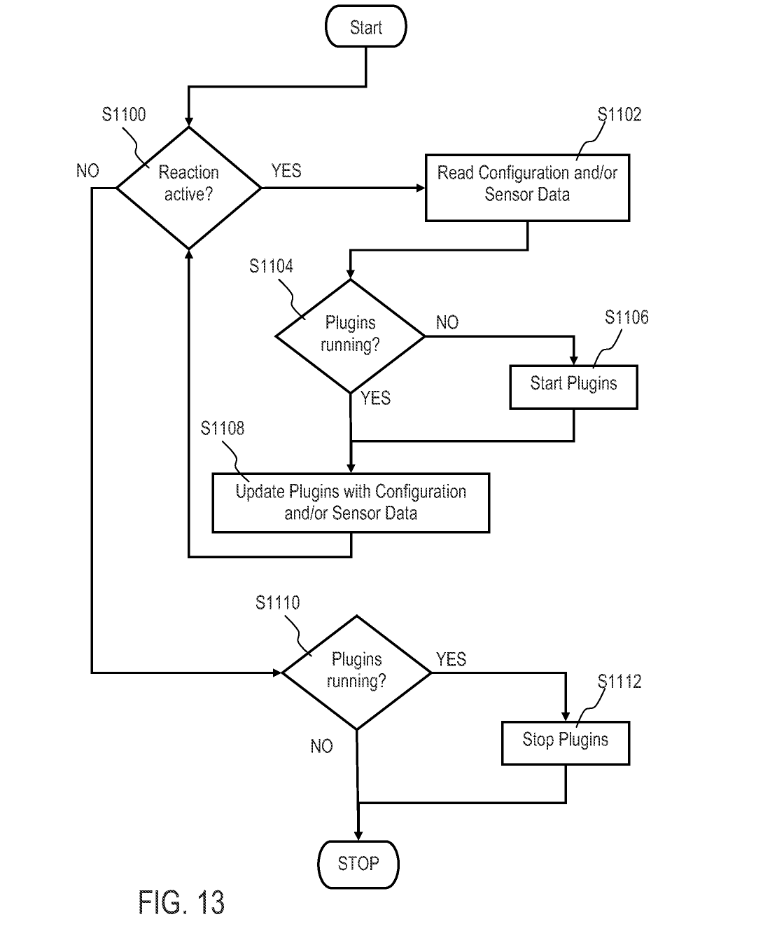

FIG. 12 and 13 show reaction and/or plugin processing being part of the method for providing additional information to a visual interface element of a graphical user interface, in accordance with an illustrative embodiment.

Referring to FIG. 12, in step S1000 the configuration of a corresponding reaction 151, 152, 161, 171, 173, 175 is read. In step S1010, associated sensor data is read. In step S1020, plugins 180, 182, 184, 186 are loaded to process the corresponding reaction 151, 152, 161, 171, 173, 175. Instep S1040, the loaded plugins 180, 182, 184, 186 are run. In step S1050, sensor data for the plugins 180, 182, 184, 186 are updated as long as the corresponding reaction 151, 152, 161, 171, 173, 175 is active.

Referring to FIG. 13, in step S1100 it is verified whether the corresponding reaction 151, 152, 161, 171, 172, 173 is active. If the corresponding reaction 151, 152, 161, 171, 172, 173 is active, configuration and/or sensor data is read in step S1102. In step S1104, it is verified whether the corresponding plugins 180, 182, 184, 186 are running. If the corresponding plugins 180, 182, 184, 186 are not running, the plugins 180, 182, 184, 186 are started in step S1106. In step S1108, the plugins 180, 182, 184, 186 are updated with the configuration and/or sensor data. Then the process returns to step S1100. If the corresponding reaction 151, 152, 161, 171, 172, 173 is not active, it is verified in step S1110 whether the corresponding plugins 180, 182, 184, 186 are running. If the corresponding plugins 180, 182, 184, 186 are running, the plugins 180, 182, 184, 186 are stopped in step S1112. If the corresponding plugins 180, 182, 184, 186 are not running, the processed is stopped.

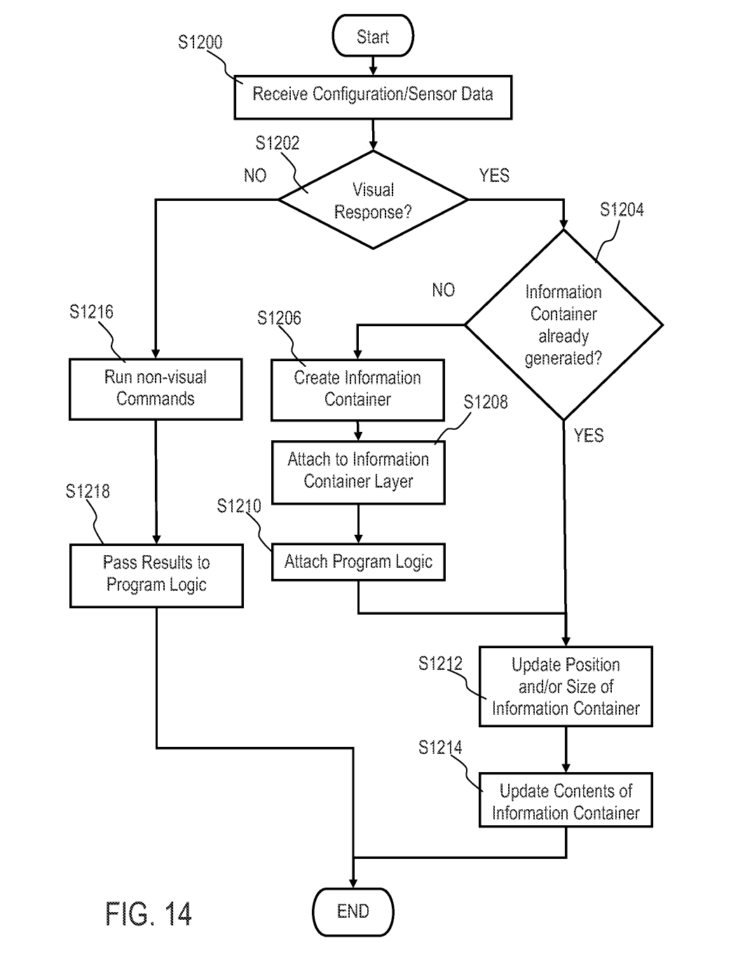

FIG. 14 shows plugin and/or visual response processing being part of the method for providing additional information to a visual interface element of a graphical user interface, in accordance with an illustrative embodiment.

Referring to FIG. 14, in step S1200 the corresponding plugin 180, 182, 184, 186 receives the configuration and/or sensor data. In step S1302, it is determined whether a visual or a non-visual response is to be performed. In case of a non-visual response of the plugin 180, 182, 184, 186, non-visual commands are run in step S1216 und the results are passed to the program logic in step S1218. In case of a visual response it is verified in step S1204 whether a corresponding information container 22 already exists. If the corresponding information container 22 already exists, the process continues with step S1212. If the corresponding information container 22 does not exist, the corresponding information container 22 is generated in step S1206. In step S1208 the information container 22 is attached to the information container layer 20. In step S1210, the program logic is attached to the generated information container 22. In step S1212, the position and/or size of the information container 22 is updated. In step S1214 the contents of the information container 22 is updated based on the configuration and/or sensor data.

The information container 22 generated by the plugins 180, 182, 184, 186 of a reaction 151, 152, 161, 171, 172, 173 is rendered by the service process 100 using the given resources of the system it is currently running on. This can be any number of standard window controls as well as elements drawn from predefined, configurable templates. A reaction 151, 152, 161, 171, 172, 173 can generate one or multiple information container 22 of different sizes, shapes, form and function. The generated information container 22 has properties similar to a regular “window control” of the system such as: type; position; size; graphical display and form.

The type of the information container 22 can be any common window control for the system the service process 100 is running on, like buttons, checkboxes, input fields, as well as predefined, user-configurable templates. The type defines the behavior and display position.

The position of the information container 22 is defined relative to the position of the assigned visual interface element 10 on the display area 3. Relative positioning uses the position of another visual interface element 10 of the display area 3 and the position information of the corresponding reaction 151, 152, 161, 171, 172, 173 has adjustments (+/− on the x/y axis) to determine the position the information container 22 will be displayed. Information gathered by the sensors 120, 130, 140 about the position of currently visible interface elements 10 can be reused for that purpose. Since the position of the information container 22 is relative to the assigned visual interface element 10 on the display area 3 the position will be updated and corrected in case the assigned visual interface element 10 is relocated. To this end the service process 100 will monitor the position of elements used for relative positioning as long as the associated visual interface elements 10 are in use. The goal for the relative positioning is to make the information container 22 “stick” to a specific position next to or on the assigned visual interface element 10.

The reactions 151, 152, 161, 171, 172, 173 can be configured how to react if the coordinates the information container 22 should be positioned at are invalid or in a non-visible area of the display area 3. Possible resolutions of this problem are positioning the information container 22 at the nearest valid visible location, accepting partial or non-visibility or resizing the information container 22 to fit the targeted location.

The size of the information container 22 is dependent on the type of the information container 22 as well as the content information and other visual interface elements 10 on the display area 3. The information container 22 can either have fixed or dynamic size. If the size is fixed, the information container 22 will be generated with the proportions as defined in the corresponding reaction 151, 152, 161, 171, 172, 173. If the size is dynamic the information container 22 can be determined in several ways that can also be combined, namely amount and/or length of the content to be displayed, type of the information container 22, size of another visual interface element 10 on the display area 3 and also the display area space available at the position the information container 22 will be rendered. The corresponding reaction 151, 152, 161, 171, 172, 173 can have any of these parameters configured to adapt the display of the information container 22 as needed.

The program logic is provided in the form of script commands stored inside the corresponding reaction 151, 152, 161, 171, 172, 173 and which are executable either when the reaction 151, 152, 161, 171, 172, 173 enters or leaves a certain state or in result to user interaction with the generated information container 22. The program logic has all information gathered by the sensors 120, 130, 140 or explicitly provided in the corresponding reaction 151, 152, 161, 171, 172, 173 available to it.

The generated information containers 22 are placed on a transparent window control layer, called information container layer 20. This information container layer 20 is provided by the service process 100 and placed on top of all other visible window controls or visual interface elements 10 of the user desktop. The information container layer 20 always remains on top of all other windows and itself will not inhibit the ability of the user to click and/or use any of the window controls or visual interface elements 10 situated below it, it is so to speak both transparent for display and clicking. Any information container 22 generated by the service process 100 will be placed at the appropriate position on the information container layer 20 thus floating above all other window controls or visual interface elements 10. The information containers 22 on the information container layer 20 are visible to the user and will react on clicks and interactions. The states of reactions 151, 152, 161, 171, 172, 173 may modify the visibility and clickability of the information containers 22.

The information container layer 20 and all information containers 22 on it can be shown and hidden by the service process 100 at any time due to direct user commands, like keyboard shortcuts, service process configuration, or as part of a setup of the corresponding reaction 151, 152, 161, 171, 172, 173. By placing the information containers 22 on a separate information container layer 20 hovering above all other window controls or visual interface elements 10, the service process 100 can create the illusion that existing applications are being extended without actually modifying them.

Embodiment of the present inventive can be implemented as an entirely software embodiment, or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

1. A method for providing additional information to a visual interface element of a graphical user interface in an operating system environment, the method comprising:
determining for each of a plurality of visual interface elements of the graphical user interface whether at least one context is assigned to at least one visual interface element base on at least one collectd information or status information in the operating system environment;
responsive to determining at least one configured context assigned collecting and storing information across all applications from at least one information or status source related to the at least one assigned context;
evaluating the collected information to determine a state of the at least one assigned context;
implementing an information container layer running across all applications on top of a display area; and
generating and placing a corresponding information container in the information container layer to be visible at a relative position to a corresponding visual interlace element of the graphical user interface on the display area.

2. The method according to claim 1, wherein the at least one information, or status source provides information of a parent visual interface element, information of a process providing the visual interface element, information of logged in users, information of system metrics, information from files on a disk, information from files in a remote system, or information from files in a database.

3. The method according to claim 1, wherein each context is associated with at least one reaction, wherein each of the at least one reaction is a configurable action executed by a background service process.

4. The method according so claim 3, wherein the at least one reaction triggers at least one plugin comprising all necessary programming and logic to create and display the at least one information container on the display area.

5. The method according to claim 3, wherein the at least one reaction triggers at least one non-visual action comprising at running a command accessing a file service or writing data to storage.

6. The method according to claim 1, wherein the information container layer is transparent to at least one user unless a corresponding information container is displayed or interacted with.

7. The method according to claim 1, wherein the information container comprises a formatted text, a formatted image, a hyperlink, or an interface extension,

8. A system comprising:
a processor
a memory coupled to the processor,wherein the memory comprises instructions which, when executed by the processor, cause the processor to provide additional information to a visual interface element of a graphical user interface in an operating system environment, the instructions comprising
an information container layer running across ail applications on top of a display area;
at least one sensor collecting status information in the operating system environment:
at least one context assigned to at least one visual interlace element (10) defining a predefined state of the operating system environment based on the status information in the operating system environment;
a data storages configured to store the status information; and
a background service process performing the following
determining for each of the at least one visual interface element of the graphical user interface whether at least, one context is assigned to at least, one visual interface element based on at least one collected information or status information in the operating system environment.
responsive to determining at least one configured context is assigned, collecting and storing information across all applications related to the at least one assigned context using the at least one sensor;
evaluating the collected information to determine a state of the at least one assigned context; and
generating and placing a corresponding information container in the information container layer to be visible at a relative position to a corresponding visual interface element of the graphical user Interface on the display area.

9. The system according to claim 8, wherein the at least one sensor collects the status information by accessing interfaces of the operating system environment and application programming interfaces to read metrics and status information of the operating system environment, or a display manager to scan for visual interface elements.

10. The system according to claim 8, wherein appearance and information type of the information container depend on state of environment of a corresponding visual interface element of the graphical user interface

11. The system according to claim 8, wherein the information container comprises a formation text, a formatted image, a hyperlink, or an interface extension.

12. The system according to claim 8, wherein the information container is implemented as an input field reacting on activity of at least one user, as capturing keyboard or mouse input, or as an image reacting transparent to activities of at least one user,

13. The system according to claim 8, wherein the visual interface element of the graphical user interface comprise a button, a panel, an input field, a radio button, a checkbox, or an image,

14. (canceled)

15. A computer program product stored on a readable storage medium, comprising computer-readable program code for causing a computer to perform a method for providing additional information to a visual interface element when said program is run on said computer, wherein the computer-readable program code causes the computer to:
determine for each of a plurality of visual interface elements of the graphical user interface Whether at least one context is assigned to at least one visual interface element Based on at least one collectd information or status information in the operating system environment;
responsive to determining at least one configured context is assigned, collect and store information across all applications from at least one information or status source related to the at least one assigned context;
evaluate the collected information to determine a state of the at least one assigned context;
implement an information container layer running across all applications on top of a display area; and
container layer to be visible at a relative position to a corresponding visual interface-container layer to be visible at a relative position to a corresponding visual interface element of the graphical user interface on the display area.

16. The computer program product according to claim 15, wherein the at least one information or status source provides information of a parent visual interface element, information- of a process providing the visual interface element, information of logged In users, information of system metrics. Information from files on a disk, information from flies in a remote system, or information from files In a database.

17. The computer program product according to claim 15, wherein each context is associated with at least one reaction, wherein each of the at least one reaction is a configurable action executed by a background service process.

18. The computer program product according to claim 1, wherein the at least one reaction triggers at least one plugin comprising all necessary programming and logic to create and display the at least one information container on the display area.

19. The computer program product according to claim 17, wherein the at least one reaction triggers at least one non-visual action comprising running a command accessing a lie service or writing data to storage.

20. The computer program product according to claim 15, wherein the information container layer is transparent to at least one riser unless a corresponding information container is displayed or interacted, with.

21. The computer program product according to claim 15, wherein the information container comprises a formatted text a formatted image, a hyperlink, or an interface extension.
